(19) United States
(12) Patent Application Publication
(10) Pub. No.: US 2024/0390800 A1
(43) Pub. Date: Nov. 28, 2024

(54) SYSTEMS AND METHODS FOR INTERACTIVE VIDEO GAME EXPERIENCE

(71) Applicant: CREA INTERACTIVITY CORP., Brooklyn, NY (US)

(72) Inventors: Elizabeth SPRATT, Jersey City, NJ (US); Kate GYLLENHAAL, Brooklyn, NY (US)

(21) Appl. No.: 18/673,933

(22) Filed: May 24, 2024

Related U.S. Application Data
(60) Provisional application No. 63/504,091, filed on May 24, 2023.

(51) Int. Cl. A63F 13/69; A63F 13/49

(52) U.S. Cl. CPC A63F 13/69; A63F 13/49

(57) ABSTRACT

The technology described herein relates to, among other topics, a system for providing a cohesive physical video game experience. The technology also relates to a networking infrastructure for synchronizing and harmonizing gameplay and game data across different software (e.g., game) modules. The technology also includes an interactive development/design platform for obtaining feedback during development/design and incorporating such feedback into the overall gameplay.

### CROSS REFERENCE TO RELATED APPLICATION(S)

This application claims priority to U.S. Patent Application No. 63/504,091, filed May 24, 2023, the entire contents of which are incorporated herein by reference.

### BACKGROUND

Video game system(s) have existed for decades. For many years, users could play the games with each other by going to arcades, or playing in local environments using different game console systems. As the popularity of playing video games has increased over the years, so has concern regarding the educational and health benefits associated with the users playing such games.

Certain technology exists for facilitating health and educational benefits to a user playing video game(s). For example, certain “stand up” video arcade game systems allow the user to dance in place while music videos play in coordination to the dance moves thus facilitating cardiovascular exercise for the user. Other systems include motion based handheld controllers allowing the user to perform actions such as swinging/throwing in free space.

However, conventional technology has certain drawbacks. For example, conventional technology usually allows the user to participate in a single game/level experience without allowing for a continuous cohesive physical experience played across different game/software modules. Moreover, the conventional technology does not provide a network infrastructure allowing for harmonization of gameplay and game data across different game/software modules. Finally, the conventional technology lacks an adequate method for obtaining user feedback and then reflecting the feedback in the overall gameplay.

Accordingly, it will be appreciated that new and improved techniques, systems, and processes are continually sought after.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BRIEF DESCRIPTION OF THE DRAWINGS

FIG. 1 shows a non-limiting example of a system 1 in which an interactive gameplay environment is implemented;

FIG. 2 shows a non-limiting example diagram of system 1 where a map of network and game module infrastructure is depicted;

FIGS. 3A-G show non-limiting example diagrams of different configurations associated with different software modules;

FIGS. 4A and 4B show non-limiting example screenshots associated with the interactive gameplay associated with system 1;

FIGS. 5A-C shows non-limiting example illustrative flowcharts for processes 500 associated with system 1;

FIG. 6 shows a non-limiting example user interface 600 associated with system 1; and

FIG. 7 shows a non-limiting example block diagram of a hardware architecture for the system.

### DETAILED DESCRIPTION OF THE TECHNOLOGY

### Selected Definitions

When it is described in this document that an action “may,” “can,” or “could” be performed, that a feature or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, component, attribute, etc. is present in at least one embodiment, though is not necessarily present in all embodiments.

As used in this document, the term “and/or” includes any and all combinations of one or more of the associated listed items.

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

### Overview

The technology described herein relates to, among other topics, a system for providing a cohesive physical video game experience. The technology also relates to a networking infrastructure for synchronizing and harmonizing gameplay and game data across different software (e.g., game) modules. That is, the technology allows for multiplayer interconnected games to be played synchronously through a continuous and cohesive physical adventure, all of which is tied together by a network infrastructure. In one example embodiment, the software modules are implemented as individual games tied together across a theme that allows for multiple games to be played in harmony in a local environment. Of course, this example is non-limiting and the technology described herein allows for the games to be played in remote environments as well.

As discussed herein, certain conventional technology exists for providing a user with a physical fitness related game experience in a video game environment. Such technology may employ a projection system for displaying (and interacting with) the game environment. However, the conventional technology uses basic graphics and rudimentary game design, and offers a library of predetermined themes and subjects that are not specifically based on environmental topics. Put simply, the content of the games is basic.

While the conventional technology may be responsive to body movement, there are no specific narratives, logic, clear goals or objectives built into the games as a whole. Moreover, the conventional technology does not obtain user feedback associated with the game development/design process, and then utilize such feedback into the video game design and development. Moreover, the conventional technology includes game design as “one off” experiences (e.g., played as standalone, separate games) that offer a wide array of content, but are not meant to be played together as a continuous cohesive physical experience (e.g., tied together by an environmental theme).

The technology described herein includes a video game experience implemented by the intersection of augmented reality, video games, and fitness. The system described herein includes multiplayer, interconnected games where participants are immersed in an experience of an adventure associated with current environmental threats.

The technology includes several distinct software modules that are playable in multiple physical game environments. The software modules can all be linked together and played synchronously through networking code. A game engine (e.g., Unity®, Unreal Engine®) library can be used to write networking code, and the network code can be contained in scripts called ClientBehavior.cs and ServerBehavior.cs. The technology can employ a peer-to-peer (P2P) connection where at least one separate computer can act as the server and any other separate computers may act as clients. In one non-limiting example, the technology may utilize a Unity GameObject in the client games called NetworkManager which has a component attached called ClientBehavior.cs. The component includes an input field capable of accepting an IP address of the server computer for connection.

Each software module can be designed to operate with a specific type of interactive hardware (e.g., laser sensor, motion sensor) connected to a computer (e.g., USB, wireless), where the interactive hardware can obtain user input. Movement/body data can be collected from the input of the interactive hardware where such data can be communicated to the game engine. The data obtained from the interactive hardware can be passed through the game engine and converted into a game object which mimics the movement of the body to execute the function/physical movement of the game for which the framework is designed. The following table provides a basic flow and description of associated processing:

| | | |
|---|---|---|
| INPUT Devices | PROCESS | OUTPUT |

(3d motion sensors, IR laser sensors) [symbol] (data sent to Unity Application software) [symbol] (projectors)

| INPUT: | PROCESS: | OUTPUT: |
|---|---|---|
| Devices that are used | Where the input data is | Where the result |
| to capture data | processed | of processed |
| and enter it | by the central | information |
| into a computer system | processing unit | is displayed |
| (mouse, keyboard, & | (hard drive of computer, | Projectors hung |
| motion and/or laser | gaming chip) where the | according to hardware |
| sensors) | application | configuration |
| | software is stored) | of specific |
| | Application Software is | game(s) where projects |
| | Unity which processes | can display the games |
| | input data | |

The software interacts with (or instructs) the game engine to recognize and utilize native game objects to represent interactive props and scenery. These fundamental objects have each been attached to original scripts in order to implement functionality for intended operation of each game.

The software modules described herein can be designed for packaging together for maximum game play advantages and experience. The network management software described herein also ties the software modules together, where the network management software serves as one centralized location where data from all games are linked and stored (e.g., for harmonization and synchronization). The software modules are multiplayer, tell an interactive story, and are driven by exploration and problem solving, where the gameplay is designed to take the player through a continuous experience in order to immerse them in the adventure theme.

The software modules have a defined software architecture that are programmed to challenge the players with different physical fitness goals. This source code determines how the physical output of each game will function in collaboration with the hardware. Furthermore, this software architecture has a defined point tracking system that updates in real-time during player engagement. This point tracking system is tied into the mechanics of each individual software module via a game manager script. The point tracking system can function the same way each time each module is played, which is executed according to its predetermined script presets, regardless of what theme or adventure is played. The modules employ a DontDestroyOnLoad (gameObject) in the GameManager to keep it active across scene loads which allows the modules to save and load points. The UI Manager handles updating the user interface (e.g., the displayed points) for the players to view.

A new environmental theme can be applied to the raw software architecture of each game/module in the process of building a new adventure. Each adventure can address a different environmental threat, and each of the games explore a different aspect of the theme. The technology ties the games together with a new theme for every adventure, and a library of adventures is available for helping the users move while also solving true-to-life environmental threats and disasters based on scientific research. Some of the adventures include a “Protect the rainforest” adventure, a “Save the Ocean” adventure, and an “Operation Galaxy” adventure (among other adventures). A general diagram showing the association among the adventures in the different software modules is depicted below.

The technology described herein thus allows for creation of different software modules playable together in an interactive and cohesive game experience. The technology can be synchronized and harmonized within the network infrastructure in order to provide a cohesive game experience across all of the software modules. In doing so, the technology advantageously improves the overall gaming experience and thus improves the overall human-computer interface. Moreover, the networking technology facilitates proper data communication between the different software modules thus providing improved bandwidth and communication between different network components.

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

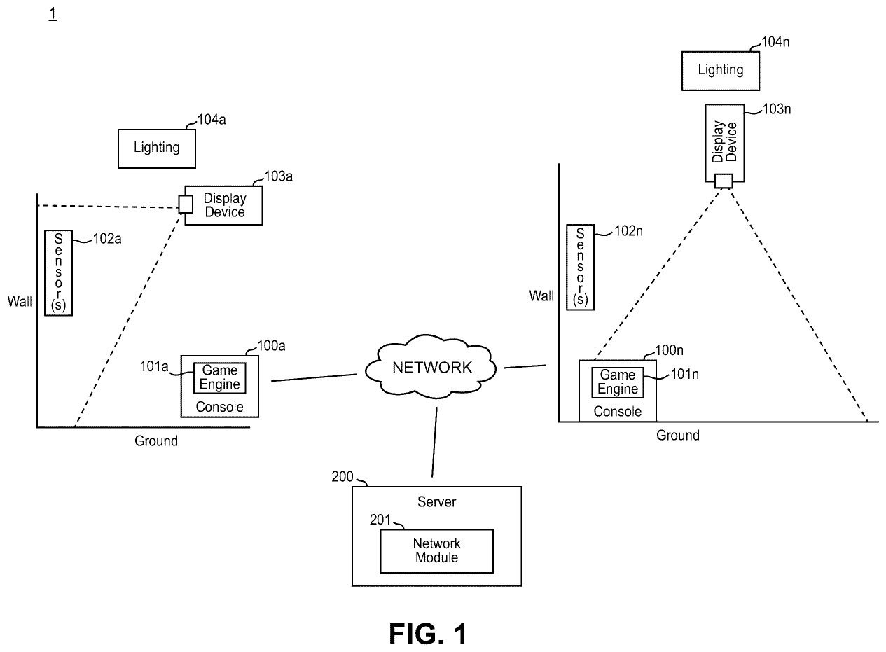

FIG. 1 shows a non-limiting example of a system 1 in which an interactive gameplay environment is implemented. The system 1 can include different components that can be configured in different various arrangements (e.g., depending upon the type of software module) in real space to provide an interactive and immersive game environment. The system 1 can include a game device (e.g., a console, a computer, a mini-computer) 100a-n where each game device may have an associated game engine 101a-n. The system may further includes sensor(s) 102a-n configured to obtain user input data. In one non-limiting example, sensor(s) 102a-n may include an infrared laser sensor(s) and/or motion sensor(s). These examples are non-limiting and sensor(s) 102a-n can include any type of device configured to obtain user input.

System 1 may also include lighting 104a-n where each of lighting 104a-n may include different audio/visual elements (e.g., light structures, speakers). In one non-limiting example embodiment, lighting 104a-n may include stage lighting fixtures where each fixture in lighting 104a-n may be linked together (e.g., “daisy chained”). Each fixture in lighting 104a-n may also be assigned a unique address so that network module 201 (e.g., of server 200) may communicate different instructions to each fixture in lighting 104a-n. It should be appreciated that lighting 104a-n may work in conjunction with other various elements of system 1 including, but not limited to, console(s) 101a-n, sensor(s) 102a-n, and/or display device(s) 103a-n.

System 1 can further include display device(s) 103a-n configured to output video (and audio) data. In one non-limiting example, display device(s) 103a-n can include a projector system. The display device(s) 103a-n are configured to output display to a wall and/or ground in which a user can interact with system 1 (e.g., using sensor(s) 102a-n). The arrangement of the display device(s) 103a-n and sensors 102a-n are configurable based on the specific type of software module in which the particular game environment is configured.

The game device(s) 100a-n include associated game engine(s) 101a-n which are used for executing the software module associated with a particular game environment. In one non-limiting example, the input obtained from sensor(s) 102a-n can be communicated to game device(s) 100a-n (e.g., via USB, via wireless communication) where game engine(s) 101a-n can interpret the input data for determining how the user is interacting with items displayed by display device(s) 103a-n.

In one example embodiment, the software associated with the software modules recognizes and utilizes native game objects in the game engine to represent interactive props and scenery. These objects are attached to original scripts in order to implement functionality for how each game is intended to operate. Each module includes a defined code framework that is scalable, and can be edited to reflect new art assets without changing the physical outputs and framework of the module. All games are ultimately projected onto the floor or wall (e.g., via display device(s) 103a-n), and the display device(s) 103a-n can be positioned in a room in a manner to ensure a large scale projected image.

The game device(s) 103a-n may communicate with a server 200 (e.g., via a network) where server 200 may include network module 201. In one non-limiting example, game device(s) 103a-n may communicate with the server 200 via a peer-to-peer connection. This example is of course non-limiting and the technology described herein envisions any manner of connectivity between game device(s) 103a-n and server 200. The connection between server 200 and device(s) 103a-n may be facilitated using network module 201. In one example embodiment, network module 201 facilitates game play and game data harmonization and synchronization between games being played using game devices(s) 103a-n.

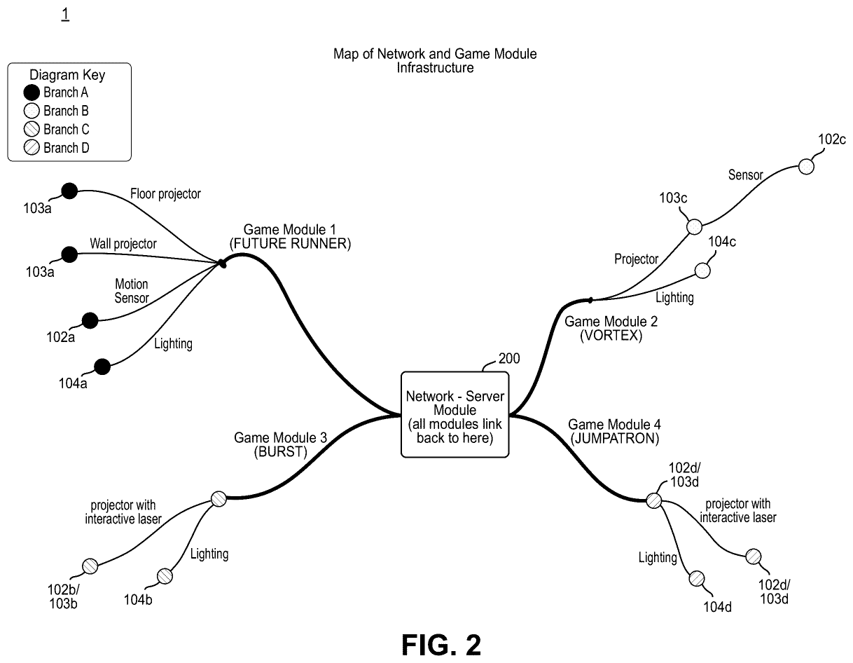

FIG. 2 shows a non-limiting example diagram of system 1 where a map of network and game module infrastructure is shown. The example of FIG. 2 shows different elements of system 1 where certain elements (e.g., sensor(s) 102a-n, display device(s) 103a-n, lighting 104a-n) are highlighted. In the example shown in FIG. 2, at least four game modules (Future Runner, Vortex, Burst, Jumpatron) are shown with different elements (e.g., floor projector, wall projector, projector with interactive laser) associated with each game module.

As can be seen in FIG. 2, the game modules communicate via server 200 where the content associated with each module is “linked” via the server 200 (e.g., using network module 201). As discussed herein, the game modules communicating via server 200 (as a non-limiting example) allow for each individual game to be implemented through an overall gaming adventure where the users can all share in the adventure in a common environment. For example, the games associated with each game module can be synchronized so that all users playing each game can share in the overall thematic adventure that is being executed with each game.

In one example embodiment, a user can play a game associated with one game module (e.g., Future Runner) where the gameplay may be harmonized with the other game modules (e.g., Vortex, Burst, Jumpatron). The users may play each of the games within relative local proximity to each other (though this example is non-limiting and the technology also envisions the games to be played at remote locations by each of the users). It should be appreciated that the examples shown in FIG. 2 are non-limiting and the technology described herein envisions any number of game modules being operated in association with each other.

As a non-limiting example, each game module is configured for synchronization with other game modules where all modules may be played over a relative fixed time period (e.g., 60 minutes). In one example embodiment, all game modules can be configured to start at a same time and play for a determinate amount of time (e.g., 5 minutes) before users may move to another game module. Various audio/visual indicators using the equipment associated with each game (e.g., lighting 104a-n, display device(s) 103a-n) may be used to indicate when and where users should transition to the next game in the overall interactive experience.

During the experience over the relative fixed time period (e.g., 60 minutes), the network's client-server architecture collects and displays points in real time. The game modules (Vortex, Burst, Future Runner, Mindset, and Jumpatron) act as individual clients, collecting points each time their module is played and feeds data from each round to the server. The server handles tracking and accumulating all points collected by each individual module every round and broadcasts a collective score amassed by all players during the 60 minute experience, as a non-limiting example. It should be appreciated that the system facilitates multiplayer collaboration.

Network module 201 (e.g., of server 200) may be used to facilitate interaction between different game modules. In particular, various audio/visual indicators (e.g., lighting sequences) are configured in a network script to guide the transition from game to game. The programmed lighting sequences may be executed by a communication protocol that controls stage lighting and other various effects. In one example embodiment, system 1 may use Digital Multiplex (DMX) as the associated communication protocol for controlling audio/visual indicators (e.g., lighting 104a-n).

In one example embodiment, lighting 104a-n may be integrated into network module 201 (e.g., a “Unity” network) using a communication interface (e.g., USB to DMX interface). Network module 201 may be configured to translate a software engine (e.g., “Unity”) digital signals into DMX-compatible signals that lighting fixtures can understand. The software engine can provide an application program interface (API) to instruct the DMX interfaces when to control the lights. A custom script (e.g., written in C#, UnityScript) can communicate with the DMX interface, where Unity variables may be mapped to trigger events in the DMX channels thereby allowing real-time control over lighting elements in lighting 104a-n.

In one example embodiment, server 200 may run on a local area network, where each game module (e.g., executed via console(s) 101a-n) and each lighting component (e.g., lighting 104a-n) may be connected to a main network switch. System 1 may also include a library of content for each game module which can include various elements. Certain elements of the library may include (but are not limited to) assets, scripts, prefabs, scenes, textures, audio, animations, materials, user interface (UI), plugins, and/or documentation.

Assets may include asset creation and/or importing where custom assets, 3D models, textures, audio files, animation, and UI elements are included in appropriate folders within an Assets directory. Each asset may be named and categorized for easy identification, retrieval, and repurposing in current and/or future game modules. Prefab may include prefab creation of reusable GameObjects with predefined components and settings. In one example embodiment, GameObjects may be “dragged and dropped” from a Hierarchy or Project view into a Prefabs folder to create prefabs which can include customizable scripts, parameters, and GameObjects.

Scripts may include script organization of custom scripts for gameplay mechanics, AI behavior, UI functionality, and other game features. Scripts may be organized into subfolders within a Scripts directory based on functionality or system (e.g., PlayerScripts/, EnemyScripts/, UI/, Managers/, Utilities/). Scenes may include scene management where each game may be divided into scenes based on levels, menus, or distinct gameplay sections, where a scenes folder may be used to load the library of content seamlessly.

System 1 may utilize version control software to track changes and collaborate with other developers (e.g., of each game module). Documentation may include documentation and/or metadata where formal documentation for assets, prefabs, scripts, and overall project structure may be contained. In one example, various elements in documentation may be tagged with metadata to facilitate fast searching. In one example embodiment, system 1 may iterate the library based on feedback, optimization needs, bug fixes, and feature enhancements.

It should be appreciated that various elements in library (e.g., of system 1) may be accessed via a user interface. For example, system 1 may include an interactive menu that allows a user to select from a library of themes that are preloaded on server 200. Upon selecting a button, the theme is automatically loaded and shown on the five gaming modules where each can be played synchronously through the server 200. Such an implementation may be achieved through a Unity user interface system with custom script via UI to Canvas. Inside the Canvas, UI elements are created for the menu (e.g., buttons indicating each theme) where an end user may interact with each element of the menu. Scrips may be “attached” to the elements (e.g., buttons) to process user input and navigation where the menu may correspondingly respond based on the user input (e.g., enabling selection of a theme). Scripts may be written in an associated language (e.g., C#) where the script executes in association with an inspector window (e.g., inside Unity) and assigns OnClick events according to the command associated with the menu button. These examples are of course non-limiting and the technology described herein envisions any variety of manner in which the user may interact with system 1.

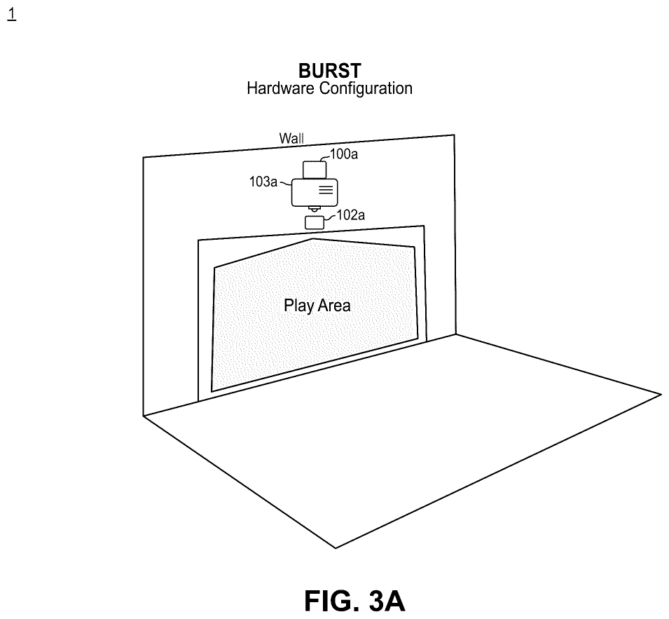

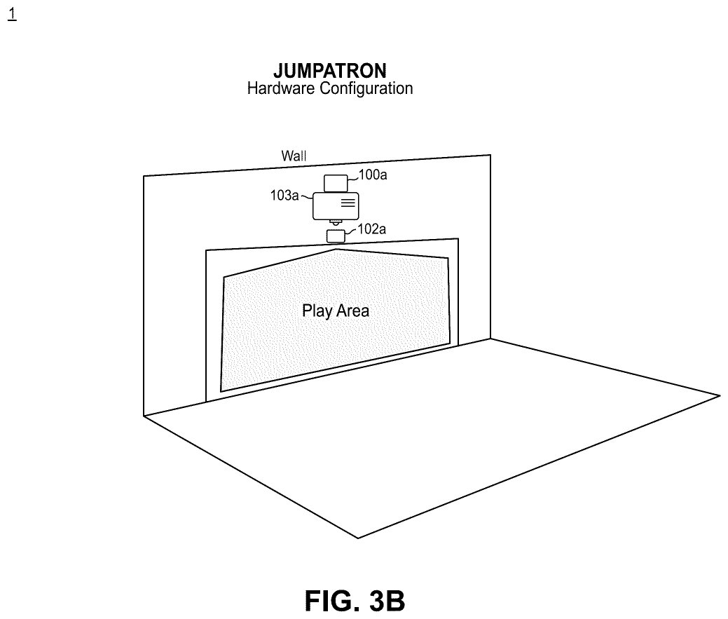

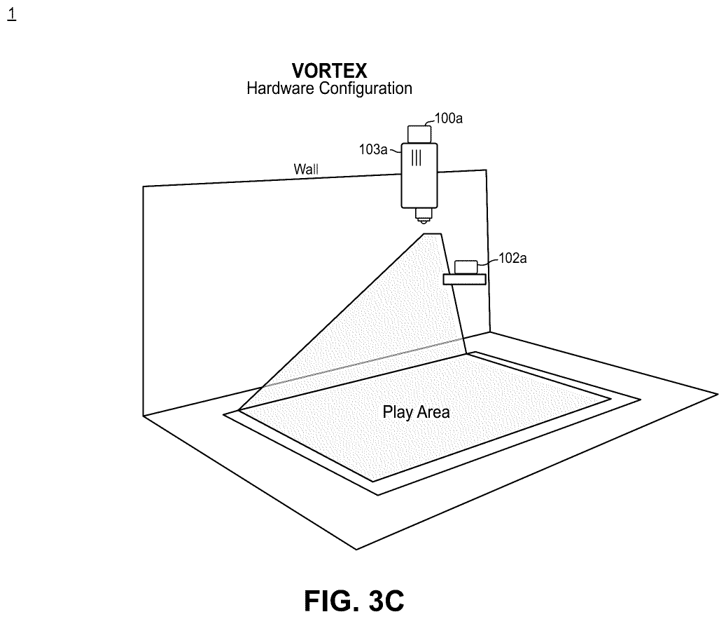

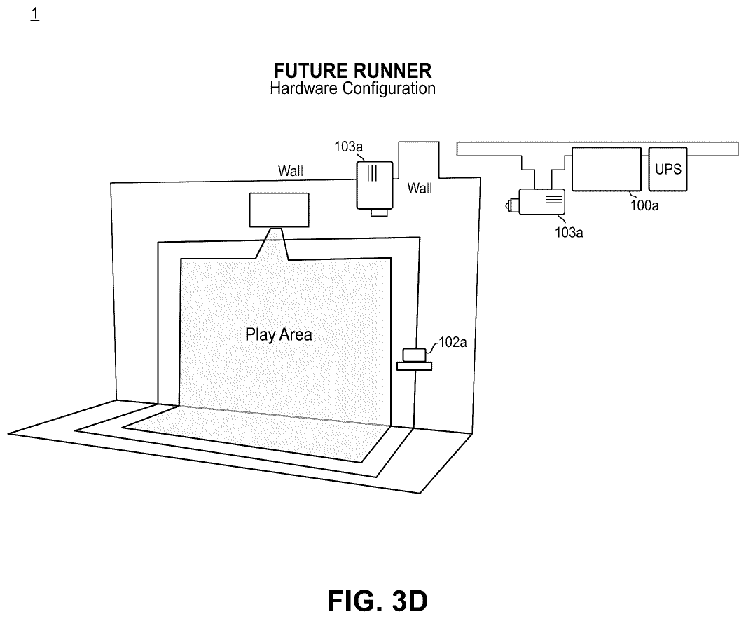

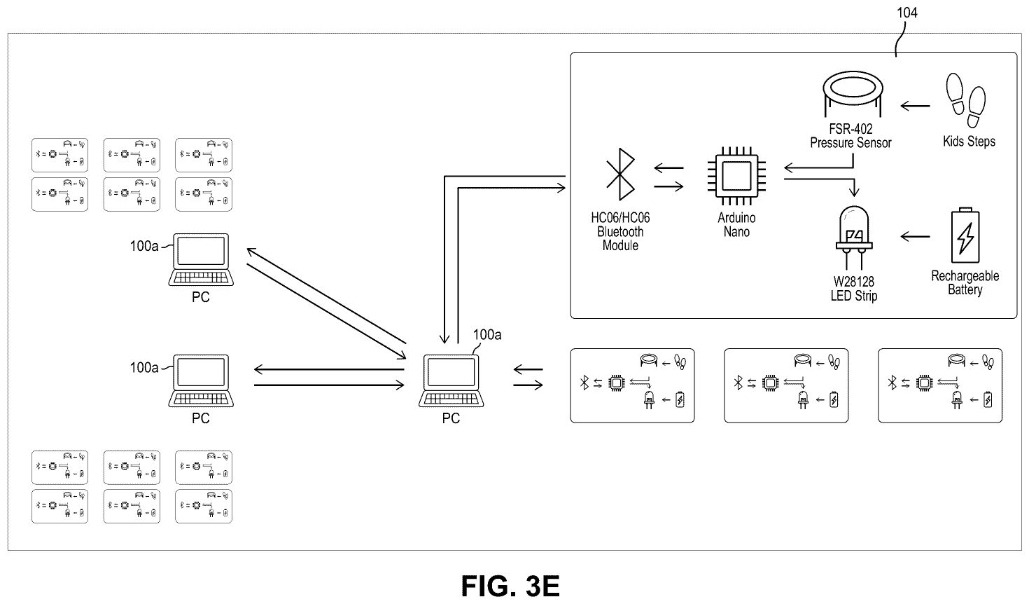

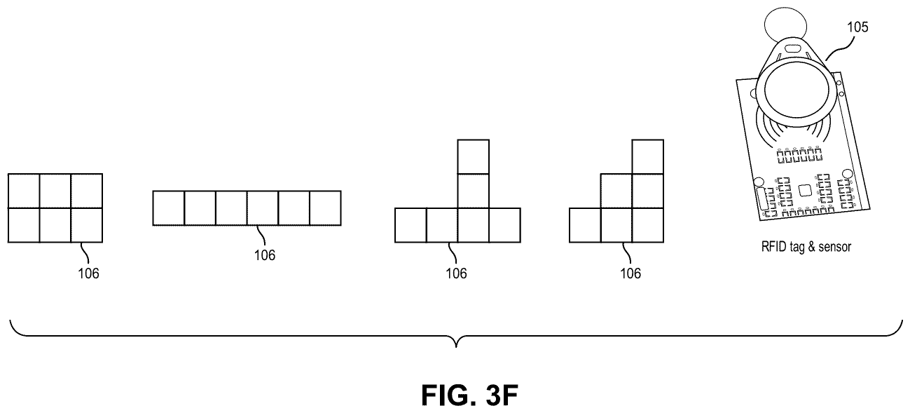

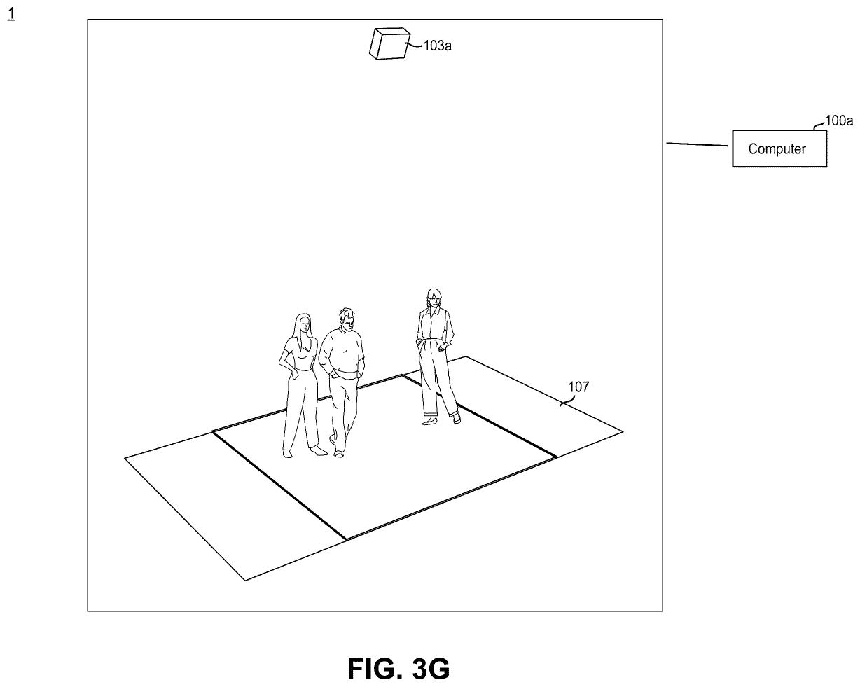

FIGS. 3A-G show non-limiting example diagrams of different hardware configurations associated with different software modules. In one non-limiting example embodiment, each software module can be associated with a respective game mode that includes, at least, a Burst module, a Jumpatron module, a Vortex module, and a Future Runner module, among other modules (described herein).

FIG. 3A shows a non-limiting example diagram of the hardware configuration of the Burst module. The configuration shown in FIG. 3A specifically depicts the positioning of the game device 100a, sensor(s) 102(a), and display device 103a. Each component may be positioned within various different dimensions and/or distances from each other. For example, play area shown in FIG. 3A may include an area 120″×75X, where projector 103a may be positioned 120″ from the ground. Likewise, the overall area associated with the Burst module may be 189″×209″. It should be appreciated that the dimensions and distances are for illustrative purposes only and are directed to non-limiting example embodiments. The technology described herein is not limited to the dimensions or distances in any fashion and envisions a variety of different values associated with such parameters for each game module.

The Burst module associated with FIG. 3A includes a fast-paced “cardio-pumping” game. In the Burst module, user speed, agility, throwing strength, accuracy, and teamwork are challenged throughout the game all while working to solve the environmental threat of the adventure. In one example embodiment, an object may be placed in the real-world environment (e.g., bean bag, ball) where the user can throw the object at the wall to “hit” items displayed by display device 103a.

Sensor(s) 102a can detect movement of the objects and determine when the object has “made contact” with the wall to understand a general physical coordinate of the contact. Upon determining the physical coordinate of the contact, the game device 100a (using game engine 101a) can determine if the object is positioned at the location of a virtual object displayed by display device 103a. A successful “hit” may result in the object being “blown up” on display while the user may obtain points for successfully hitting the displayed object.

FIG. 3B shows a non-limiting example diagram of the hardware configuration of the Jumpatron module. The configuration shown in FIG. 3B specifically depicts the positioning of the game device 100a, sensor(s) 102(a), and display device 103a. Each component may be positioned with different dimensions and distances relative to each other (and relative to the wall and the floor).

The Jumpatron module associated with FIG. 3B includes a game designed to give users plyometric/jump training challenges. In this high-speed game, users jump, hop, squat, and reach in all directions, working together to hit targets to defend the environmental threat featured in the game. In one example embodiment, the user can stand near the displayed game image where sensor(s) 102a will detect the general movement of the user. For example, the user may jump in the air to touch different objects displayed by display device(s) 103a where sensor(s) 102a will detect contact associated with the displayed object.

Sensor(s) 102a may detect movement of the user and determine when the user has “made contact” with the wall to understand a general physical coordinate of the contact. Upon determining the physical coordinate of the contact, the game device 100a (using game engine 101a) can determine if the contact of the user is positioned at the location of a virtual object displayed by display device 103a. A successful “hit” may result in the object being “blown up” on display while the user may obtain points for successfully hitting the displayed object.

FIG. 3C shows a non-limiting example diagram of the hardware configuration of the Vortex module. The configuration shown in FIG. 3C specifically depicts the positioning of the game device 100a, sensor(s) 102(a), and display device 103a. Each component may be positioned with different dimensions and distances relative to each other (and relative to the wall and the floor).

The Vortex module associated with FIG. 3C includes an agility-based floor game designed to challenge users to jump, lunge, hop and spring on their feet in every direction to destroy environmental threats as they appear on the floor. In one example embodiment, the user can stand over the displayed game image where sensor(s) 102a will detect the general movement of the user. For example, the user may jump on different objects displayed by display device(s) 103a on the ground, where sensor(s) 102a will detect where the user lands after the jump.

Sensor(s) 102a can detect movement of the user and determine when the user has “made contact” with the ground to understand a general physical coordinate of the contact. Upon determining the physical coordinate of the contact, the game device 100a (using game engine 101a) can determine if the contact of the user is positioned at the location of a virtual object displayed by display device 103a. A successful “hit” may result in the object being “blown up” on display while the user may obtain points for successfully hitting the displayed object.

FIG. 3D shows a non-limiting example diagram of the hardware configuration of the Future Runner module. The configuration shown in FIG. 3D specifically depicts the positioning of the game device 100a, sensor(s) 102(a), and display devices 103a and 103b. Each component may be positioned with different dimensions and distances relative to each other (and relative to the wall and the floor).

The Future Runner module associated with FIG. 3D includes a cardio-driven running game, designed to challenge users to sprint through different terrains dodging, spinning and leaping to avoid obstacles as they race against the countdown clock. The game is projected onto the floor and wall enhancing the immersive experience and the environmental challenge the players are up against for this adventure. In one non-limiting example embodiment, sensor(s) 102a may include one or more motion sensors configured to monitor movement of the user as the user performs cardio-driven tasks. For example, sensor(s) 102a may detect a user running in place and/or moving in a manner to reflect dodging various obstacles. These examples are of course non-limiting and the technology described herein envisions any variety of devices usable as sensor(s) 102a.

FIG. 3E shows a non-limiting example diagram of the hardware configuration of a power pod module. The configuration shown in FIG. 3E specifically depicts the positioning of the game device 100a and hardware 104. The hardware 104 may include certain components such as a Bluetooth module, LED strip, an Arduino Nano, a rechargeable battery, and/or a pressure sensor, among other elements.

The power pod module associated with FIG. 3E includes a series of interactive pods that transition the players from game to game. Every time a player steps on a pod it will light up, make a mysterious sound that relates to the Adventure theme, and points will be added to the score. The formation of the pod changes with each transition. At random points, power pods, when stepped on, will flash with an unusual tone scoring the player an extra amount of points (e.g., 200 points). The system records data in real-time, such as reaction times and accuracy, and sends this information back to the network for analysis and point tracking.

The pods will instruct the players to move at varying speeds from game to game. To avoid the dangers of the environmental disaster surrounding them they must stay on the power pods at all times during transitions. In one non-limiting example embodiment, the hardware 104, which includes a pressure sensor, can be positioned in various spots on the floor and the player can step on the equipment to provide input to game device(s) 100a, where such input can be reflected in the gameplay.

FIG. 3F shows a non-limiting example diagram of the hardware/game configuration of a mindset module. The configuration shown in FIG. 3F shows non-limiting various arrangements of a game puzzle(s) 106 as well as RFID tag/sensor(s) 105 used in association with the mindset module.

The mindset module associated with FIG. 3F shows an “escape the room” genre game where players will encounter a series of hidden, interactive puzzles that they must work together to solve. If all the puzzle pieces are placed in the correct position and the puzzle is solved it will light up, flashing wildly and unlock a new part of the mindset mission. There will be a series of projected puzzled images on the wall. Players will be given six (6) equal sides, thirteen by thirteen (13×13) cubes spread a distance of four feet from the wall projection. This configuration is of course non-limiting and the technology described herein envisions any configuration for each element.

The cubes will be lightly weighted to increase the physical challenge of the game. The objective of the game is for the players to run and pick up the cubes and together match them to the projected puzzle outline on the wall before the clock runs. If they succeed, they will score points and reveal the clue to the next puzzle. Depending on how fast the players can solve each puzzle in a given amount of time the more clues will be disclosed and the higher their score. This game reinforces mental agility, quick problem-solving, spatial awareness and team collaboration.

FIG. 3G shows a non-limiting example diagram of the hardware/game configuration of a GagaRama module. The configuration shown in FIG. 3G specifically depicts the positioning of the display device(s) 103a. Each component may be positioned with different dimensions and distances relative to each other (and relative to the wall and the floor), where one or more users may position themselves in area 107. System 1 shown in FIG. 3G may also include any of the other various components shown herein. For example, system 1 may include one or more game device(s) 100a and/or one or more sensor(s) 102(a) (not shown).

The GagaRama module associated with FIG. 3G includes a variant of dodgeball and is a version of the game Gaga. Inside an octagonal Gaga pit, players slap or hit the ball, aiming to hit other players at or below the knees. If you are hit, you are out. The GagaRama mixes the traditional Gaga game with interactive game play. Projection-mapped images will move in different patterns and speeds on the floor.

The images relate to the current Adventure, and players need to avoid the moving images in order to keep from losing scored points all while not being hit by the Gaga ball. The ball will also light up whenever it is touched. The hardware configuration associated with the GagaRama module can include a projection area needing to cover, as a non-limiting example, a 10 ft×10 ft wide area, with an off-center projection. To reduce user shadows, the configuration needs to ensure the projector lens is located above the center of the projection area. The examples shown in FIGS. 3A-G are of course non-limiting and the technology described herein envisions any variety of game/software modules having different hardware and software configurations.

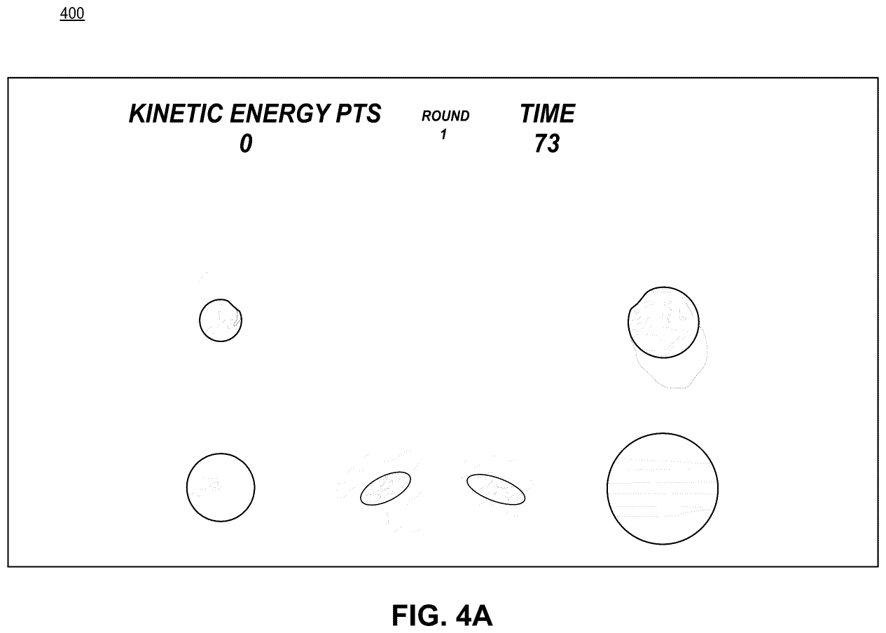

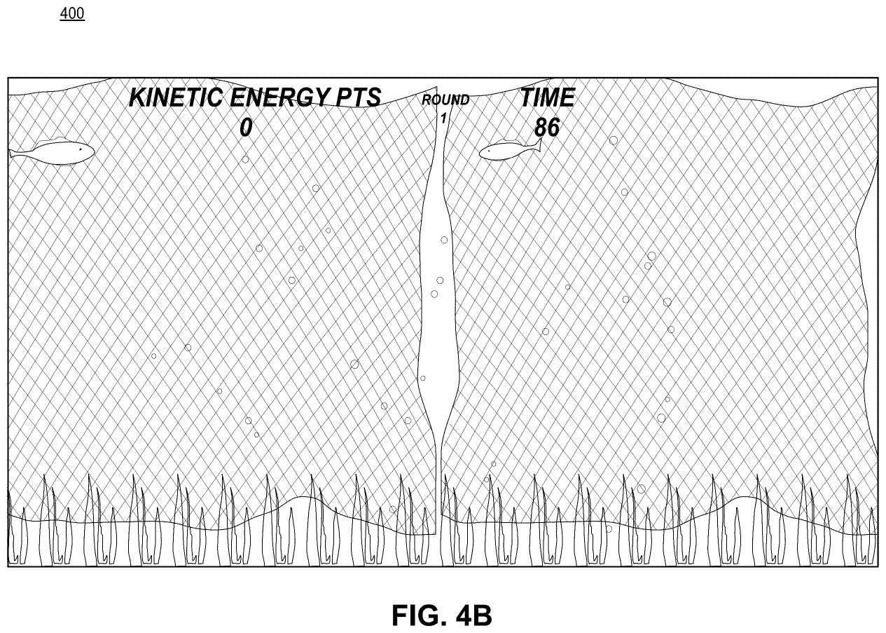

FIGS. 4A and 4B show non-limiting example screenshots associated with the interactive gameplay described herein. FIGS. 4A and 4B show specific non-limiting example displays of different games associated with the overall adventure. It should be appreciated that the items shown in FIGS. 4A and 4B can be displayed via display devices 103a-n as the game modules are executed in system 1.

In the example shown in FIG. 4A, user interface 400 is displayed where different visual elements are depicted. In the example shown in FIG. 4A, different planets (e.g., in outer space) are shown where display items are depicted above the game elements. The display items in FIG. 4A include a points portion, a level/round indicator, and/or a time value indicator. These examples are of course non-limiting and the technology described herein envisions any variety of items or information displayable in interface 400.

In the example shown in FIG. 4B, user interface 400 is displayed depicting an underwater-type theme. For example, user interface 400 in FIG. 4B shows one or more fish objects where a sea-bed is shown beneath the objects swimming above. Similar to FIG. 4A, the user interface 400 in FIG. 4B includes various display items shown near the top of user interface 400. For example, display items in user interface 400 of FIG. 4B may include a points portion, a level/round indicator, and/or a time value indicator. These examples are of course non-limiting and the technology described herein envisions any variety of items or information displayable in interface 400.

The technology described herein includes a content development approach allowing user feedback to be incorporated into the game development and design. In one example embodiment, the system (which could include a cloud based system) features a different environmental theme that runs through all games, and these themes are designed to fit the framework of the raw modules which are coded to challenge fitness goals. All system(s) 1 are associated with a cloud based application that is configured to accept different user feedback via the cloud based application. A development team may use certain input obtained from the cloud based application in generating different gameplay and/or game objects that are implemented via system 1.

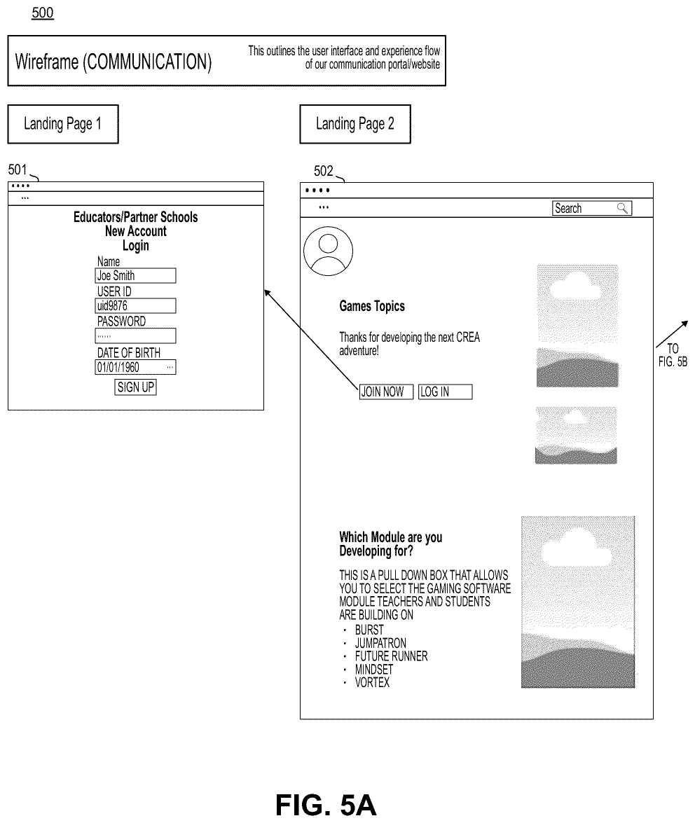

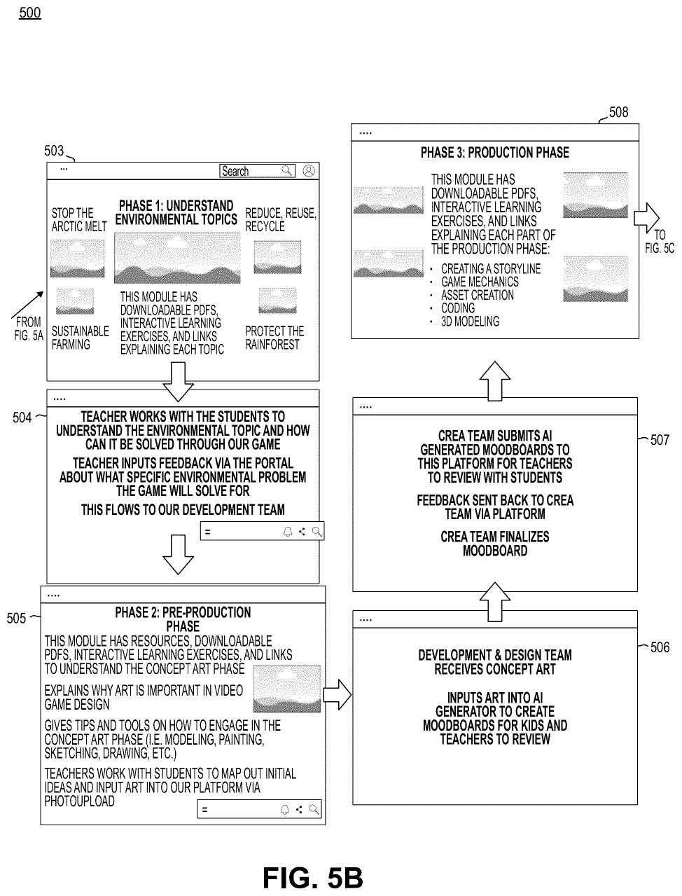

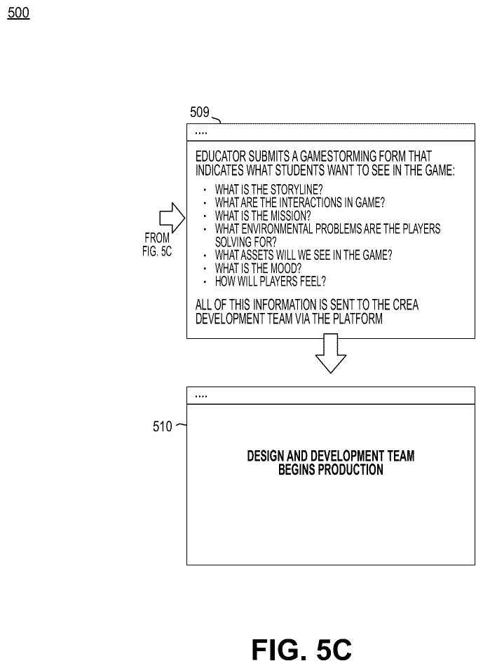

FIGS. 5A-C show non-limiting examples of the wireframe for the cloud based communication platform that streamlines the design and development processes of the gaming modules associated with system 1. FIGS. 5A-C specifically shows illustrative example flowcharts of various processes associated with the design and development processes of the gaming modules associated with system 1. The process begins (at step 501) by providing a landing page where users (e.g., educator/partner schools) have access to the system. The landing page could include a user name and login prompt and/or provide prompts for creating new user accounts.

The process can proceed to a subsequent landing page (at step 502) where game topics may be introduced and/or selection of different modules is available. In one example embodiment, a user may be able to select one or more of the various software modules (e.g., Burst, Jumpatron, Future Runner, Mindset, Vortex) to explore aspects of design and/or development.

The process proceeds (at steps 503 and 504) by introducing the game topic (e.g., environmental problem) to one or more users. In one example embodiment, the process could include collaboration with teachers and/or school children at a local school to understand the overall game concept to be designed. This phase of the process could include downloading items (e.g., PDF documents) with interactive learning exercises and links explaining each topic. In one example embodiment, users (e.g., teachers and/or students) can work together to understanding the environmental topic and/or theme and how it can be solved via the game. User(s) may input feedback regarding the environmental topic (e.g., via a user interface 600) where the same can be provided to a development team.

The process proceeds (at step 505) to a pre-production phase where further engagement between developers and users may occur. In one example embodiment, the pre-production phase may include a module having resources, downloadable items (e.g., PDF documents), interactive learning exercises, and/or links for understanding the concept art phase. The module may explain why artwork is important in the design process and may provide advice as to how to engage in the concept art phase. Users may work together to map out initial ideas where submissions can be made via a portal of system 1 (e.g., via an upload element in user interface 600). A development/design team may receive the submissions (at step 506), where the submissions (e.g., artwork) can be input into artificial intelligence (AI) generators to create mood boards for users to review. Collaboration may continue between developers/designers and users (at action 507) where system 1 may facilitate the collaborative process.

The process may continue (at step 508) to a production phase where further details associated with production are explored. In one example embodiment, the production phase may include another module having resources, downloadable items (e.g., PDF documents), interactive learning exercises, and/or links for explaining portions of the production phase. These portions could include, but are not limited to, creating a storyline, game mechanics, asset creation, coding, and/or 3-D modeling.

In one example embodiment, the process could include (at steps 509 and 510) a user submitting “gamestorming” materials where the design and/or development team may begin production. For example, a user may submit a form indicating what other users (e.g., students) may desire in a game module. The form could include aspects related to the storyline, interactions in the game, the overall mission, environmental problems to be solved, mood of the game, assets seen in the game, and/or feedback related to how users may feel. System 1 may accept this feedback (e.g., via one or more user interface(s) 600) where developers and/or designers can user the information in the development process.

It should be appreciated that the theme(s) are decided by the collaborative partnerships with the users (e.g., student-based design team). When art assets are designed and coded for a new adventure/them, the emotional, social and physical experience changes thereby offering a unique and exciting challenge for the players. As explained above, the process begins by creating a game design document, which describes the software and outlines the design and flow of each game. The development team organizes ideas by creating a structural outline that includes the desired look and feel, the game play, the game logic, the narrative, the sound effects and sound score. The games are not completed until the entire student-based team agrees on the final version.

It should be appreciated that all of the information obtained with the processes associated with FIGS. 5A-C can be documented in a cloud-based memory system. The technology also allows for a cross-collaboration platform for the development team and all partner(s) that will automate these business and creative processes. This platform will be one single place where schools can login, input data and communicate with the development team. The development team will then be able to manage their workflow and development timelines from there.

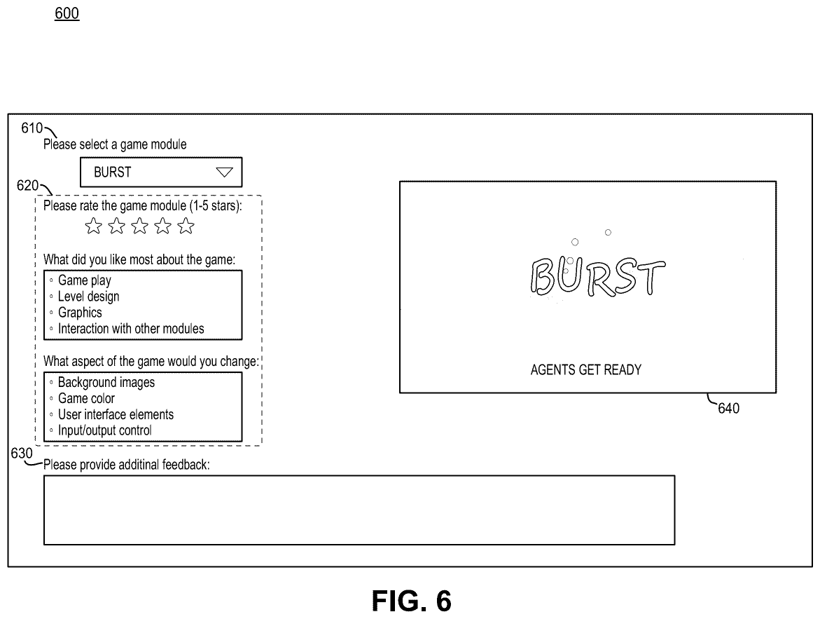

FIG. 6 shows a non-limiting example user interface 600 for incorporating development feedback for system 1. In one example embodiment, user interface 600 can be implemented as a portal (e.g., a web-based portal) where one or more users can provide feedback regarding system and/or provide additional input that can be used in developing various software modules (among other aspects).

User interface 600 can include one or more input elements as well as other various display elements. For example, user interface 600 can include an input portion 610 enabling a user to select a particular software module to provide various feedback. Selection of an item from portion 610 may cause display portion 640 to display an image (or play an audio/video file) associated with the selection. In the example shown in FIG. 6, input portion 610 shows the “burst” module as being selected from a menu item, where display portion 640 shows a visual representation associated with the “burst module.”

In one example embodiment, a user can enter inputs into various form (or input) elements where such information can be submitted via system 1. For example, entry of various input could be transmitted to system 1 and/or stored in a memory of system 1. A developer could access the information (e.g., via a separate user interface) where further development of one or more software modules (or any other aspect associated with system 1) can be implemented.

In the example shown in FIG. 6, user interface 600 includes, at least, selectable input portion 620 and open input portion 630. In selectable input portion 620, various selectable elements may be presented where a user can select different answers to various questions, as a non-limiting example. For example, selectable input portion 620 may include an item asking the user to rate the module (e.g., from one to five stars).

Likewise, selectable input portion 620 may include different selectable options where the user may select one or more items in an answer to an inquiry. For example, selectable input portion 620 may include an item asking a user which elements the user enjoyed most about a selected module where different items may be selectable as response (e.g., “gameplay,” “level design,” “graphics,” and/or module interaction). Selectable input portion 620 may include an item asking a user which elements of the module they would change (e.g., “background images,” “game color,” “user interface elements,” and/or “input/output control”). These examples are of course non-limiting and the technology described herein envisions any other items selectable by a user in input portion 620.

User interface 600 may also include an open input portion 630 where the user may provide any type of input. For example, open input portion 630 may include a dialogue/text input portion where a user can input any type of feedback. As a non-limiting example, a user could provide a detailed description of various feedback in the open input portion 630 where such information can be used in various system and/or game development. These examples are of course non-limiting and the technology described herein envisions any variety of mechanisms for providing input including, but not limited to, uploading various input items (e.g., documents, PDFs) and/or providing audio/visual feedback via interface 600.

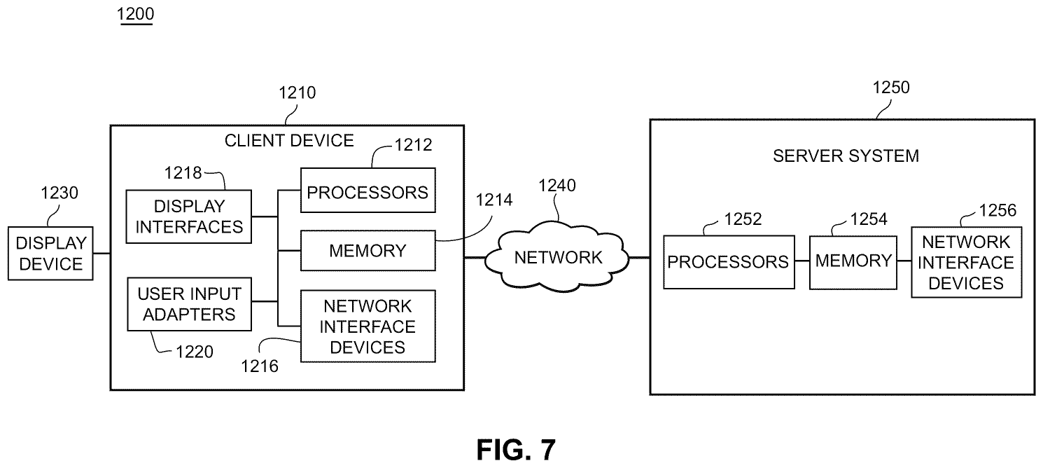

FIG. 7 shows a non-limiting example block diagram of a hardware architecture for system 1200. In the example shown in FIG. 7, the client device 1210 communicates with a server system 1250 via a network 1240. The network 1240 could comprise a network of interconnected computing devices, such as the internet. The network 1240 could also comprise a local area network (LAN) or could comprise a peer-to-peer connection between the client device 1210 and the server system 1250. As will be described below, the hardware elements shown in FIG. 7 could be used to implement the various software components and actions shown and described above as being included in and/or executed at the client device 1210 and server system 1250.

In some embodiments, the client device 1210 (which may also be referred to as “client system” herein) includes one or more of the following: one or more processors 1212; one or more memory devices 1214; one or more network interface devices 1216; one or more display interfaces 1218; and one or more user input adapters 1220. Additionally, in some embodiments, the client device 1210 is connected to or includes a display device 1230. As will explained below, these elements (e.g., the processors 1212, memory devices 1214, network interface devices 1216, display interfaces 1218, user input adapters 1220, display device 1230) are hardware devices (for example, electronic circuits or combinations of circuits) that are configured to perform various different functions for the computing device 1210.

In some embodiments, each or any of the processors 1212 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1212 uses an instruction set architecture such as x86 or Advanced RISC Machine (ARM).

In some embodiments, each or any of the memory devices 1214 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1212). Memory devices 1214 are examples of non-volatile computer-readable storage media.

In some embodiments, each or any of the network interface devices 1216 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1218 is or includes one or more circuits that receive data from the processors 1212, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1230, which displays the image data. Alternatively or additionally, in some embodiments, each or any of the display interfaces 1218 is or includes, for example, a video card, video adapter, or graphics processing unit (GPU).

In some embodiments, each or any of the user input adapters 1220 is or includes one or more circuits that receive and process user input data from one or more user input devices (not shown in FIG. 7) that are included in, attached to, or otherwise in communication with the client device 1210, and that output data based on the received input data to the processors 1212. Alternatively or additionally, in some embodiments each or any of the user input adapters 1220 is or includes, for example, a PS/2 interface, a USB interface, a touchscreen controller, or the like; and/or the user input adapters 1220 facilitates input from user input devices (not shown in FIG. 7) such as, for example, a keyboard, mouse, trackpad, touchscreen, etc. . . .

In some embodiments, the display device 1230 may be a Liquid Crystal Display (LCD) display, Light Emitting Diode (LED) display, or other type of display device. In embodiments where the display device 1230 is a component of the client device 1210 (e.g., the computing device and the display device are included in a unified housing), the display device 1230 may be a touchscreen display or non-touchscreen display. In embodiments where the display device 1230 is connected to the client device 1210 (e.g., is external to the client device 1210 and communicates with the client device 1210 via a wire and/or via wireless communication technology), the display device 1230 is, for example, an external monitor, projector, television, display screen, etc. . . .

In various embodiments, the client device 1210 includes one, or two, or three, four, or more of each or any of the above-mentioned elements (e.g., the processors 1212, memory devices 1214, network interface devices 1216, display interfaces 1218, and user input adapters 1220). Alternatively or additionally, in some embodiments, the client device 1210 includes one or more of: a processing system that includes the processors 1212; a memory or storage system that includes the memory devices 1214; and a network interface system that includes the network interface devices 1216.

The client device 1210 may be arranged, in various embodiments, in many different ways. As just one example, the client device 1210 may be arranged such that the processors 1212 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the client device 1210 may be arranged such that: the processors 1212 include two, three, four, five, or more multi-core processors; the network interface devices 1216 include a first network interface device that implements Ethernet and a second network interface device that implements WiFi and/or Bluetooth; and the memory devices 1214 include a RAM and a flash memory or hard disk.

Server system 1250 also comprises various hardware components used to implement the software elements described herein. In some embodiments, the server system 1250 (which may also be referred to as “server device” herein) includes one or more of the following: one or more processors 1252; one or more memory devices 1254; and one or more network interface devices 1256. As will explained below, these elements (e.g., the processors 1252, memory devices 1254, network interface devices 1256) are hardware devices (for example, electronic circuits or combinations of circuits) that are configured to perform various different functions for the server system 1250.

In some embodiments, each or any of the processors 1252 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1252 uses an instruction set architecture such as x86 or Advanced RISC Machine (ARM).

In some embodiments, each or any of the memory devices 1254 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1252). Memory devices 1254 are examples of non-volatile computer-readable storage media.

In some embodiments, each or any of the network interface devices 1256 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the server system 1250 includes one, or two, or three, four, or more of each or any of the above-mentioned elements (e.g., the processors 1252, memory devices 1254, network interface devices 1256). Alternatively or additionally, in some embodiments, the server system 1250 includes one or more of: a processing system that includes the processors 1252; a memory or storage system that includes the memory devices 1254; and a network interface system that includes the network interface devices 1256.

The server system 1250 may be arranged, in various embodiments, in many different ways. As just one example, the server system 1250 may be arranged such that the processors 1252 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the server system 1250 may be arranged such that: the processors 1252 include two, three, four, five, or more multi-core processors; the network interface devices 1256 include a first network interface device that implements Ethernet and a second network interface device that implements WiFi and/or Bluetooth; and the memory devices 1254 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the client device or the server system, each of which will be referred to individually for clarity as a “component” for the remainder of this paragraph, are implemented using an example of the client device 1210 or the server system 1250 of FIG. 7. In such embodiments, the following applies for each component: (a) the elements of the client device 1210 shown in FIG. 7 (i.e., the one or more processors 1212, one or more memory devices 1214, one or more network interface devices 1216, one or more display interfaces 1218, and one or more user input adapters 1220) and the elements of the server system 1250 (i.e., the one or more processors 1252, one or more memory devices 1254, one or more network interface devices 1256), or appropriate combinations or subsets of the foregoing, are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the respective memory devices (e.g., in various embodiments, in a volatile memory device such as a RAM or an instruction register and/or in a non-volatile memory device such as a flash memory or hard disk) and all actions described herein as performed by the software modules are performed by the respective processors in conjunction with, as appropriate, the other elements in and/or connected to the client device 1210 or server system 1250; (c) alternatively or additionally, to the extent it is described herein that the component processes and/or otherwise handles data, in some embodiments, such data is stored in the respective memory devices (e.g., in some embodiments, in a volatile memory device such as a RAM and/or in a non-volatile memory device such as a flash memory or hard disk) and/or is processed/handled by the respective processors in conjunction, as appropriate, the other elements in and/or connected to the client device 1210 or server system 1250; (d) alternatively or additionally, in some embodiments, the respective memory devices store instructions that, when executed by the respective processors, cause the processors to perform, in conjunction with, as appropriate, the other elements in and/or connected to the client device 1210 or server system 1250, each or any combination of actions described herein as performed by the component and/or by any software modules described herein as included within the component.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

The technology described herein thus allows for creation of different software modules playable together in an interactive and cohesive game experience. The technology can be synchronized and harmonized within the network infrastructure in order to provide a cohesive game experience across all of the software modules. In doing so, the technology advantageously improves the overall gaming experience and thus improves the overall human-computer interface. Moreover, the networking technology facilitates proper data communication between the different software modules thus providing improved bandwidth and communication between different network components.

### Selected Definitions

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Further Applications of Described Subject Matter

Although process steps, algorithms or the like, including without limitation with reference to the figures, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed.

Moreover, it is not necessary for a device or method to address each and every problem sought to be solved by the present invention, for it to be encompassed by the invention. No embodiment, feature, element, component, or step in this document is intended to be dedicated to the public.

While the technology has been described in connection with what is presently considered to be an illustrative practical and preferred embodiment, it is to be understood that the technology is not to be limited to the disclosed embodiment, but on the contrary, is intended to cover various modifications and equivalent arrangements.

1. A system for coordinating game play, the system comprising:
a server device having at least a processor and a memory; and
a plurality of client devices, wherein
each of the plurality of client devices includes a processor and a memory,
each client device is configured to:
execute a game program in association with a selected game module, wherein the selected game module corresponds to a theme associated with games executed by the plurality of client devices;
obtain input data, via an input device, from a user;
update a game state of the game program in association with the obtained input data;
generate, for display, a game display in associated with the selected game module; and
communicate the game state of the game program to the server device, and
the server device is configured to:
obtain the game state of the game program from each client device;
manage the game state of the game program of each client device; and
communicate the managed game state of the game program to each client device.

2. The system of claim 1, wherein the server device is configured to synchronize the game state between the games executed by the plurality of client devices.

3. The system of claim 2, wherein
the server device is configured to transmit the synchronized game state to each of the plurality of client devices, and
each of the plurality of client devices is configured to receive the synchronized game state and synchronize the game state between each client device.

4. The system of claim 1, further comprising:
a plurality of projectors configured to project the game display, wherein each client device includes an associated projector from the plurality of projectors.

5. The system of claim 1, wherein the input device includes a motion sensing device configured to obtain motion data associated with the user.

6. The system of claim 1, wherein the input device includes a pressure sensing device configured to detect pressure applied by the user.

7. The system of claim 1, wherein each client device is arranged in a same area where users can move between areas associated with each client device.

8. The system of claim 1, wherein each client device includes additional equipment arranged in a specific configuration associated with the respective game module.

9. The system of claim 1, wherein the system is configured to generate a user interface configured to accept user feedback associated with development of each game module.

10. The system of claim 1, wherein the game modules include any of: a burst module, a future runner module, a vortex module, and/or a jumpatron module.

11. A client system, comprising:
a processor; and
a memory configured to store computer readable instructions that, when executed by the processor, cause the client system to:
execute a game program in association with a selected game module, wherein the selected game module corresponds to a theme associated with the game program;
obtain input data, via an input device, from a user;
update a game state of the game program in association with the obtained input data;
generate, for display, a game display in associated with the selected game module; and
communicate the game state of the game program to a server system.

12. The client system of claim 11, wherein the client system is further caused to:
receive an updated game state from the server system; and
update the game state of the game program based on the received updated game state.

13. The client system of claim 12, wherein the updated game state includes a synchronized game state between the client device and at least one additional client device.

14. The client system of claim 11, further comprising:
a plurality of projectors configured to project the game display.

15. The client system of claim 11, wherein the input device includes a motion sensing device configured to obtain motion data associated with the user.

16. The client system of claim 11, wherein the input device includes a pressure sensing device configured to detect pressure applied by the user.

17. A server system, comprising:
a processor; and
a memory configured to store computer readable instructions that, when executed by the processor, cause the server system to:
obtain a plurality of game states associated with game programs executing on a plurality of client devices;
manage the plurality of game states of the game programs of each client device; and
communicate the managed game state of the game program to each client device.

18. The server system of claim 17, wherein the server system is further caused to:
synchronize the game state between the games executed by the plurality of client devices.

19. The server system of claim 18, wherein the server system is further caused to:
transmit the synchronized game state to each of the plurality of client devices, wherein each client device is configured to receive the synchronized game state and synchronize the game state between each client device.

20. The server system of claim 17, further comprising:
a networking module configured to manage the game state between each of the plurality of client devices.
